(19) United States
(12) Patent Application Publication
(10) Pub. No.: US 2005/0107158 A1
(43) Pub. Date: May 19, 2005

(54) Advertisement system, advertisement method, and program thereof

(76) Inventors: Hiroaki Kanisawa, Hino-shi (JP); Makoto Miyashita, Shiojiri-shi (JP)

Correspondence Address: Sughrue Mion, 2100 Pennsylvania Avenue N W, Washington, DC, 20037-3213, US

(21) Appl. No.: 10/505,142

(22) PCT Filed: Feb. 21, 2003
(86) PCT No.: PCT/JP03/01937

(30) Foreign Application Priority Data
Feb. 25, 2002 (JP) 2002-48470

(51) Int. Cl. A63F 13/00

(52) U.S. Cl. 463/30; 463/29; 463/42

(57) ABSTRACT

An image control processing section controls a game playback device to employ an advertising image being an image for advertising a product or a service, as a character image used in a game screen. The image control processing section comprises an advertising image information database that stores advertising image information, which is information related to a product or service including advertising image data, and an advertising image selection device that selects an advertising image of a product having a better advertising effectiveness from the advertising image database, by referencing information from among; information related to a store where a user terminal is installed, a period of time, a date, a day of the week, and a time elapsed from when a user using a user terminal sits down, taken as a start time.

### TECHNICAL FIELD

The present invention relates to an advertising system, an advertising method and a program therefor which carries out advertising of products or services by means of a game on a user terminal available for video games.

### BACKGROUND ART

Conventionally in video game systems for use with video games, an advertising method in which an advertising image which advertises a product or service is embedded in the background and so on of a game screen, and the user is made to catch sight of the advertising image with the expectation that the product or service will be made to be recognized, has been proposed.

Since the conventional advertising method is in the background of the game screen as described above, there are cases where users do not become aware of the advertisement or do not pay particular attention to the advertisement even if aware of it, and there is the problem that the effectiveness of the advertising is uncertain.

### DISCLOSURE OF INVENTION

An object of the present invention is to provide an advertising system, an advertising method and a program therefor, which are capable of improving advertising effectiveness by drawing attention to advertising images during the course of a game.

The gist of the present invention is to address the issues mentioned above, and is an advertising system having a game playback device which provides a game screen in a display section of a user terminal, and comprises an image control device which controls the game playback device to employ an advertising image being an image for advertising a product or a service, as a character image used in the game screen. Therefore a character image which is highly likely to draw the attention of the user during the course of the game, can be employed as an advertising image.

Also, the term, “user terminal”, may include a computer terminal capable of connecting to the Internet, a dedicated terminal for ordering products or for information presentation, and so forth.

Thus, compared to the case of displaying an advertising image at the edge of the screen or in the background of the game, there is a higher possibility that the advertising image, which is a character, will draw attention during the course of the game, and consequently better advertising effectiveness can be achieved.

Furthermore, the gist of the present invention is that in the advertising system there is further provided: a playback control device that controls the game playback device so as to include an order detection device that detects the product or the service displayed in the game screen as the character image, and an order information receiving device that receives order information related to the order of the product or the service detected by the order detection device. Therefore orders for a product or service placed on an advertising image displayed as a character in the game can be received.

Thus, since advertised products or services are to be directly purchased by users, sales of products or services are promoted and advertising effectiveness can be improved.

Also, users are able to enjoy shopping while they enjoy the game.

Furthermore, the gist of the present invention is that in the advertising system there is provided: an advertising image information database that stores advertising image information, which is information related to the product or the service including advertising image data which are electronic data of the advertising image; and an advertising image selection device that selects the advertising image having a better advertising effectiveness from the advertising image database, according to one or a plurality of information from among; information related to a store where the user terminal is installed, a period of time, a date, a day of the week, and a time elapsed from a predetermined event related to the user using the user terminal taken as a start time. Therefore an advertising image judged to be able to gain better advertising effectiveness according to various information can be selected from the advertising image information database.

Thus, an advertising image having better advertising effectiveness can be employed as the advertising image employed as a characters in the game.

Also, the gist of the present invention is that in the advertising system there is further provided: a score computing device, which computes a score by carrying out predetermined calculations according to a course of a game; a score information database which sorts past scores in descending order and assigns ranks to them, and associates and stores top scores that are ranked above a predetermined rank with scorer information, which is information related to the users who played the game and gained the top scores; and a score information display device which associates the top scores and the scorer information referenced from the score information database and displays them on the display section. Therefore the score can be computed according to the course of the game having various advertising images exposed.

Moreover, the advertising system is able to store the information about the scorers who gained top scores in the score information database, and manage it.

Thus, competition between users is encouraged by displaying scorers of top scores on the display section, and use of the game can be promoted.

Also, the gist of the present invention is that in the advertising system there is further provided: a scorer information retrieval device which retrieves the scorer information when a computed score, which is a score that the computing device computes, is greater than the top score referenced from the score information database; and a database update device which stores the computed score associated with retrieved scorer information, as a new top score in the score information database. Therefore when a user gains a score that is higher than the past top score, it can be stored as a new top score in the score information database.

Thus, information of the latest top scores can be provided.

Moreover, the gist of the present invention is that in the advertising system there is further provided an image enlargement device that enlarges the advertising image and displays it on the display section. Therefore an enlargement of the advertising image can be displayed at optional timing when the advertising image is displayed small as a character image of the game.

Thus, the product image can be enlarged at times when an impression will be made with the user, and the user can be made to recognize the details of the advertising image, and the effectiveness of the advertising can be improved.

Also, in the advertising system of the present invention, in a case where the user terminal has a sound emitting device that emits sound, the advertising image information additionally includes call information for calling information relating to the product or the service, and there is further provided a call control device that controls the sound emitting device to make reference to the call information included in the advertising image information from the advertising image information database, and call out information relating to the product or service. Therefore various sounds and sound effects can be emitted in time with the advertising image being displayed as a character image of the game.

Thus, as the advertising image is displayed, the name of the product placed in the advertising image can be phonated, and the effectiveness of the advertising can be improved.

Moreover, in an advertising method of the present invention, in an advertising method employing a game playback device to provide a game screen on a display section of a user terminal, the method involves controlling the game playback device to employ an advertising image being an image for advertising a product or a service, as a character image used in the game screen.

Also, a program of the present invention is a program used in an advertising system having a game playback device which provides a game screen in a display section of a user terminal, for executing on a computer processing for controlling the game playback device to employ an advertising image being an image for advertising a product or a service, as a character image used in the game screen.

### BRIEF DESCRIPTION OF THE DRAWINGS

FIG. 1 is a block diagram showing a schematic construction of an advertising system that employs a game, according to a first embodiment of the present invention.

FIG. 2 is a diagram showing a schematic construction of an order terminal 100 of the advertising system in the first embodiment of the present invention.

FIG. 3 is a diagram showing a schematic construction of a product order management device 12 of the advertising system in the first embodiment of the present invention.

FIG. 4 is a block diagram showing an internal structure of a game control section 16 of the product order management device 12 in to the first embodiment of the present invention.

FIG. 5A is a diagram showing a configuration example of a screen information database 22a of the order terminal 10 in the first embodiment of the present invention.

FIG. 5B is a diagram showing a configuration example of a game information storage section 22b of the order terminal 10 in the first embodiment of the present invention.

FIG. 6A is a diagram showing a configuration example of a product information database 32a of the product order management device 12 in the first embodiment of the present invention.

FIG. 6B is a diagram showing a configuration example of a stock information database 32b of the product order management device 12 in the first embodiment of the present invention.

FIG. 7A is a diagram showing a configuration example of a terminal information database 32c of the product order management device 12 in the first embodiment of the present invention.

FIG. 7B is a diagram showing a configuration example of an order information database 32d of the product order management device 12 in the first embodiment of the present invention.

FIG. 8A is a diagram showing a configuration example of a store-facility information database 32e of the product order management device 12 in the first embodiment of the present invention.

FIG. 8B is a diagram showing a configuration example of an orderer information database 32f of the product order management device 12 in the first embodiment of the present invention.

FIG. 9 is a diagram showing a configuration example of an advertising image information database 16v of a game control section 16 in the first embodiment of the present invention.

FIG. 10A is a diagram showing a configuration example of a game information database 16x of the game control section 16 in the first embodiment of the present invention.

FIG. 10B is a diagram showing a configuration example of a score information database 16y of the game control section 16 in the first embodiment of the present invention.

FIG. 11 is a diagram showing an example of a preparation instruction screen 50 provided by an advertising system in the first embodiment of the present invention.

FIG. 12 is a diagram showing an example of a catering instruction screen 60 provided by the advertising system in the first embodiment of the present invention. FIG. 13 is a diagram showing one example of a product order screen 70 that is displayed on a display section 23 by an order terminal 10, in the first embodiment of the present invention.

FIG. 14 is a diagram showing one example of a product order screen 70′ that is displayed on the display section 23 by the order terminal 10, in the first embodiment of the present invention.

FIG. 15A is a diagram showing one example of a game screen 80 that is displayed on the display section 23 by the order terminal 10, in the first embodiment of the present invention.

FIG. 15B is a diagram showing one example of a grouping screen 85 that is displayed on the display section 23 by the order terminal 10, in the first embodiment of the present invention.

FIG. 16 is a flow diagram showing an operation which selects an advertising image taken as a game character and displays this on the order terminal 10, in a process in which the product order management device 12 of the advertising system manages product orders, in the first embodiment of the present invention.

FIG. 17 is a diagram showing a specific example of information stored in an advertising image information database 16v for the advertising system to charge for the exposure of the advertising image, in the first embodiment of the present invention.

FIG. 18 is a block diagram showing a schematic construction of an advertising system employing a game according to a second embodiment of the present invention.

### BEST MODE FOR CARRYING OUT THE INVENTION

Hereinafter, the present invention is described through embodiments of the invention. However, the following embodiments do not restrict the invention described within the scope of the patent claims. Moreover, not all of the combinations of the characteristics described in the embodiments are necessarily required as a means for solving the problems.

Firstly, as a first embodiment of the advertising system, a case is described, with reference to the diagrams, in which a game that employs advertising images is provided for the orderer (user) employing an ordering terminal (user terminal) for placing orders for food and drink at a restaurant.

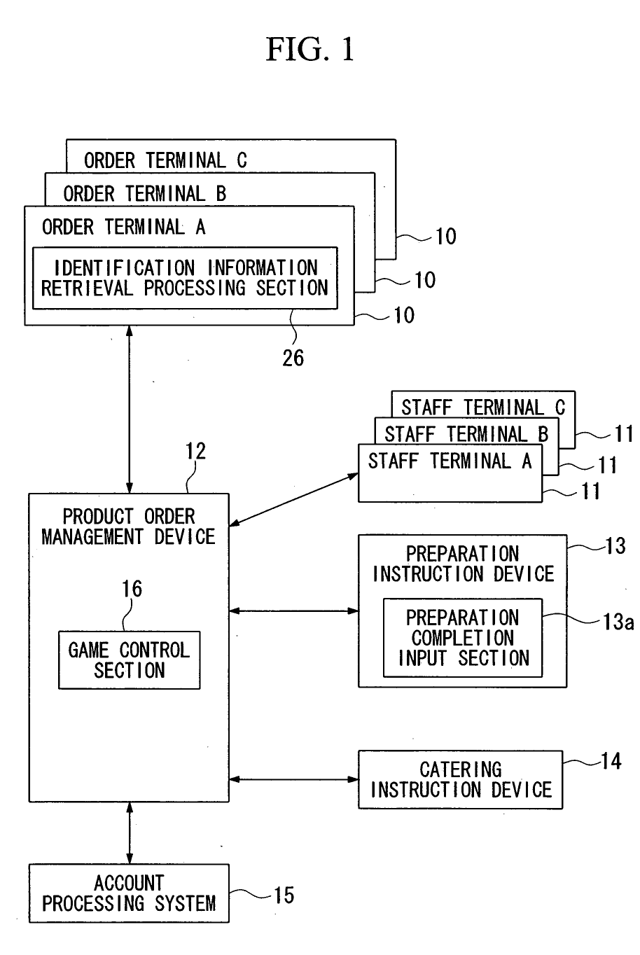

FIG. 1 is a block diagram showing the schematic construction of the advertising system that employs a game, according to the first embodiment of the present invention.

In this diagram, reference symbol 10 denotes an order terminal A, an order terminal B, an order terminal C and so forth (hereinafter referred to as the order terminal 10) that displays a product order screen that prompts the orderer to place and select an order for the required product or service, and that retrieves the order information. Also, the order terminal 10 has an identification information retrieval processing section 26 that reads the orderer identification code from a magnetic card that has an orderer identification code recorded thereon, and that is distributed to each orderer to identify the orderer. Also, the user (orderer) is able to use the game on the order terminal 10. Detailed construction of the terminal 10 is described later.

Reference symbol 11 denotes a staff terminal A, a staff terminal B, a staff terminal C and so forth (hereinafter referred to as the staff terminal 11), being a terminal for staff, that displays instructions to staff working at a restaurant, and information provided for staff and so forth, and allows various information input from staff. Also, changes of the game contents provided on the order terminal 10 may be instructed from the staff terminal 11.

Reference symbol 12 denotes a product order management device that associates the order information that the order terminal 10 retrieves, with an orderer identification code that the identification information retrieval processing section 26 retrieves, and manages it, and controls various information that is displayed on the order terminal 10 according to the order information. Also, the product order management device 12 has a game control section 16 that makes a game available on the order terminal 10. Furthermore, the game control section 16 employs advertising images as characters in the game. Also, the game control section 16 employs the order information managed by the product order management device 12 and controls the types of advertising image to further improve advertising effectiveness. Detailed internal structure of the product order management device 12 and the game control section 16 will be described later.

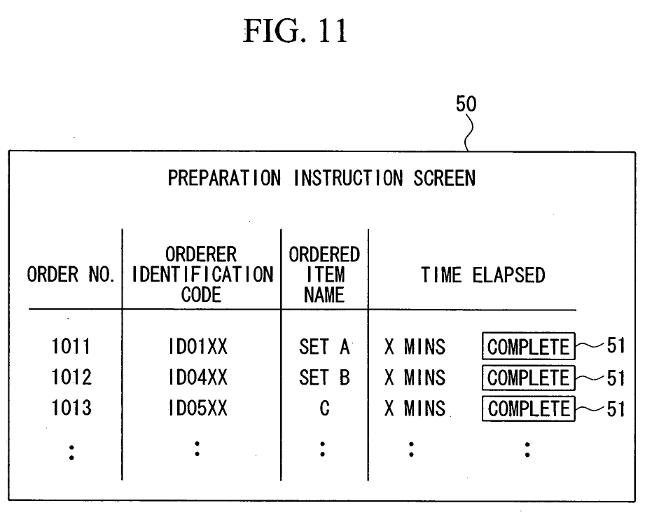

Reference symbol 13 denotes a preparation instruction device that has a display section that displays a preparation instruction screen 50 shown in FIG. 11 as a preparation instruction that instructs a cook who prepares the food and drink to prepare the food and drink that the orderer requires. FIG. 11 is a diagram showing an example of a preparation instruction screen 50 provided by the advertising system in the first embodiment of the present invention. As shown in the diagram, the preparation instruction screen 50 includes “order No”, which is a code that identifies the order, “orderer identification code”, which identifies the orderer, “ordered product name”, which is the name of the ordered product identified by “order No”, and “elapsed time”, which shows the elapsed time from the moment the order is placed. Also, the preparation instruction screen 50 includes a “completion button” 51 that is pressed when the preparation is complete. Thus, a preparation completion input section 13a, which the preparation instruction device 13 has, transmits preparation completion information indicating the completion of an ordered product displayed on a row on which the “completion button” is displayed, and the row where the “completion button” is pressed is deleted from the preparation instruction screen 50.

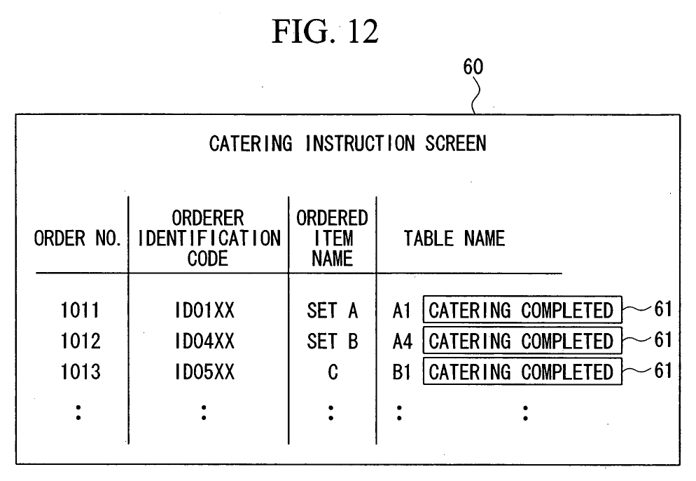

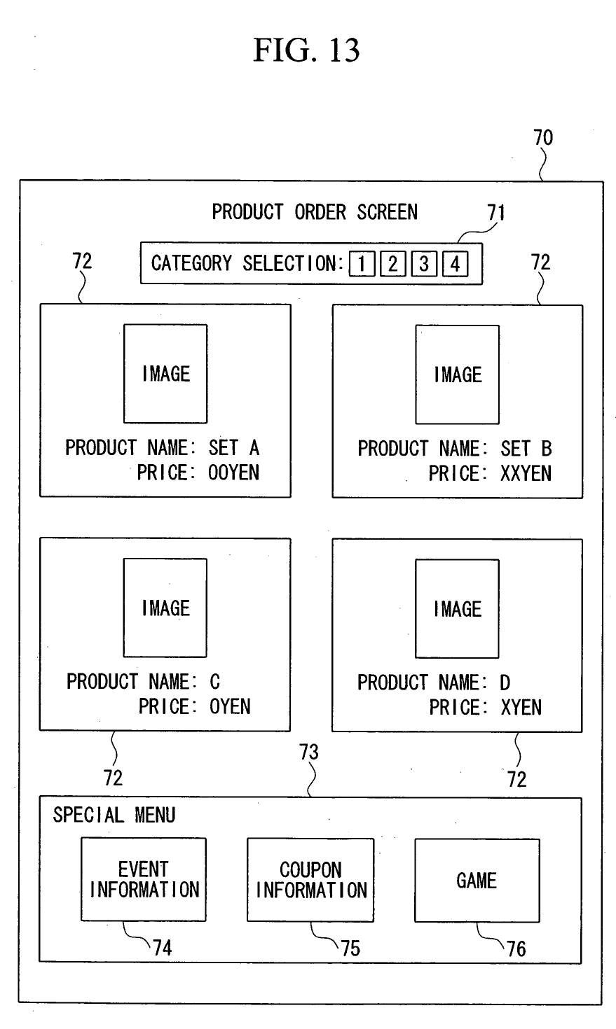

Reference symbol 14 denotes a catering instruction device with a display section that displays the instruction screen shown in FIG. 12 as a catering instruction that instructs for prepared food and drink to be taken to the table where the orderer sits. FIG. 12 is a diagram showing an example of the catering instruction screen 60 displayed by the advertising system of the first embodiment of the present invention. As shown in the diagram, in addition to “order No”, “orderer identification code”, and “ordered product name” described in FIG. 11, there is included a “table code”, which is information that identifies the table to which the ordered product is to be catered. Also, the catering instruction screen 60 includes a “catered button”, which is pressed when catering is carried out, or has been completed. Thus, completion of the catering is reported to the product order management device 12, and the row where the “catered button” 61 is pressed is deleted from the catering instruction screen 60.

Reference symbol 15 denotes an account processing system that carries out the accounting process of the total charge for all the products ordered (or ordered and catered) by the orderer from the product order management device 12 according to the orderer identification code. The advertising system of the present invention is constructed from the above. Also, communication between the above mentioned order terminal 10, the staff terminal 11, the product order management device 12, the preparation instruction device 13, the catering instruction device 14, and the account processing system 15 is preferably done using wireless communication, an exclusive line, or LAN (local area network), and so forth.

Furthermore, the order terminal 10, the staff terminal 11, the product order management device 12, the preparation instruction device 13, the catering instruction device 14, and the account processing system 15 have a display apparatus (or a display section) such as a CRT (Cathode Ray Tube), a liquid crystal display or such, and an input device (or an input section) such as a keyboard or a mouse. Also, the input devices that input commands or data to the computer are not limited to the above mentioned keyboard and mouse that are generally used, and a pointing device such as a trackball and so forth, and an image scanner, an optical character recognition device (OCR), a barcode reader, a handwriting input device, a voice recognition device, a touch panel or so on may be employed.

Next, the internal structure of the order terminal 10 is described.

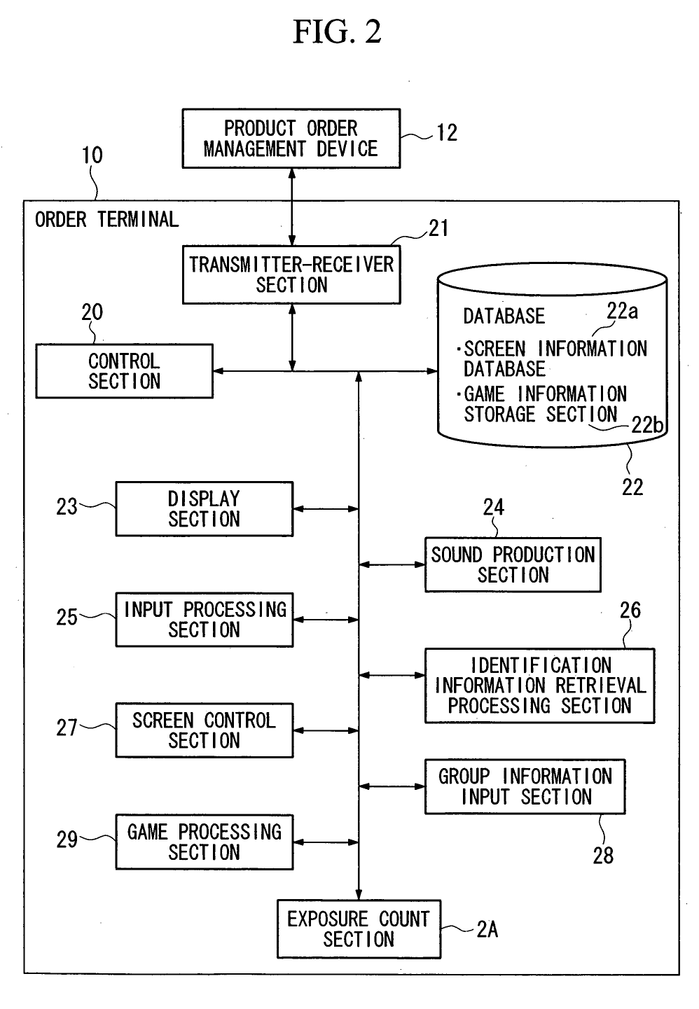

FIG. 2 is a diagram showing the schematic construction of the order terminal 10 of the advertising system in the first embodiment of the present invention. In the diagram, reference symbol 20 denotes a control section, which controls data in the order terminal 10. Reference symbol 21 denotes a transmitter-receiver section that carries out communication with the product order management device 12. Reference symbol 22 denotes a database that stores various kinds of information used on the order terminal 10. Reference symbol 23 denotes the display section that displays information that prompts product orders. Reference symbol 24 denotes the sound production section that emits the voiced information that prompts product orders, and sound effects of the game. In the present embodiment, the display section 23 is a liquid crystal display section with a touch panel.

Here, the screen information database 22a, and an example of construction of the game information storage section 22b, of the database 22 are described.

Firstly, a configuration example of the screen information database 22a is described with reference to the diagrams.

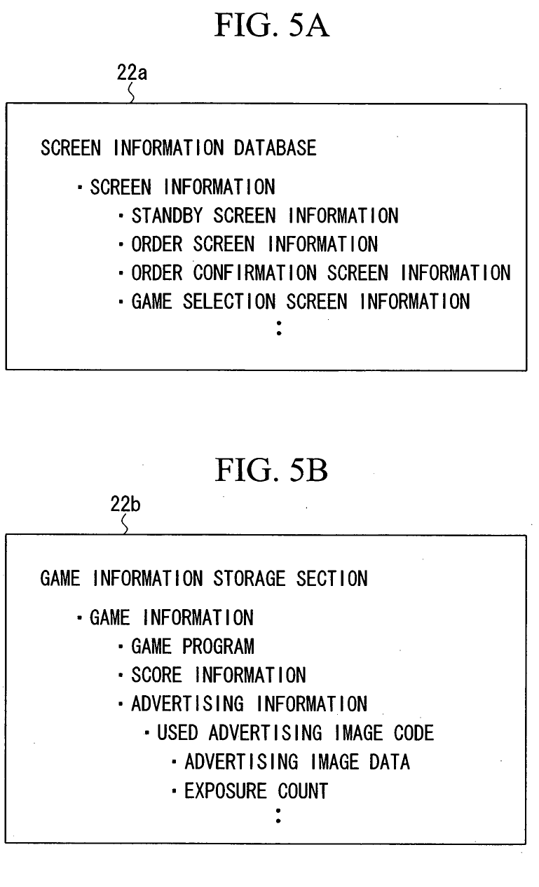

FIG. 5A is a diagram showing a configuration example of the screen information database 22a of the order terminal 10 in the first embodiment of the present invention. In the diagram, “screen information” refers to information that becomes templates for various screens displayed on the display section 23. “Standby screen information” refers to the template information of the screen displayed on the display section 23 of the order terminal 10 of the table where no user is seated, or the screen displayed on the display section 23 until the user is seated at the table and the magnetic card has been swiped through the identification information retrieval processing section 26. A screen displaying advertising information, announcement information or similar, for example, is preferable as the standby screen that the order terminal 10 displays on the display section 23. “Order screen information” stores the template information for the screen to display, for example, the product order screen 70 shown in FIG. 13 on the display section 23. FIG. 13 is a diagram showing one example of the product order screen 70 that the order terminal 10 in the first embodiment of the present invention displays on the display section 23. In the diagram, the category selection field 71 is a field where the category of the product to be ordered, for instance, “Japanese meal” 1, “Western meal” 2, “desert” 3, or “drink” 4, is selected. The product display field 72 is a field where the product image, product name, and price are displayed.

Also, the special menu field 73 is a field including buttons that provide various services when pressed. In the diagram, the button 74 is a button for displaying event information, which is information relating to various events, on the display section 23 when pressed. The button 75 is a button for displaying coupon information, which is information relating to discount coupons for products or service charges, on the display section 23 when pressed. The button 76 is a button for displaying a game selection screen on the display section 23.

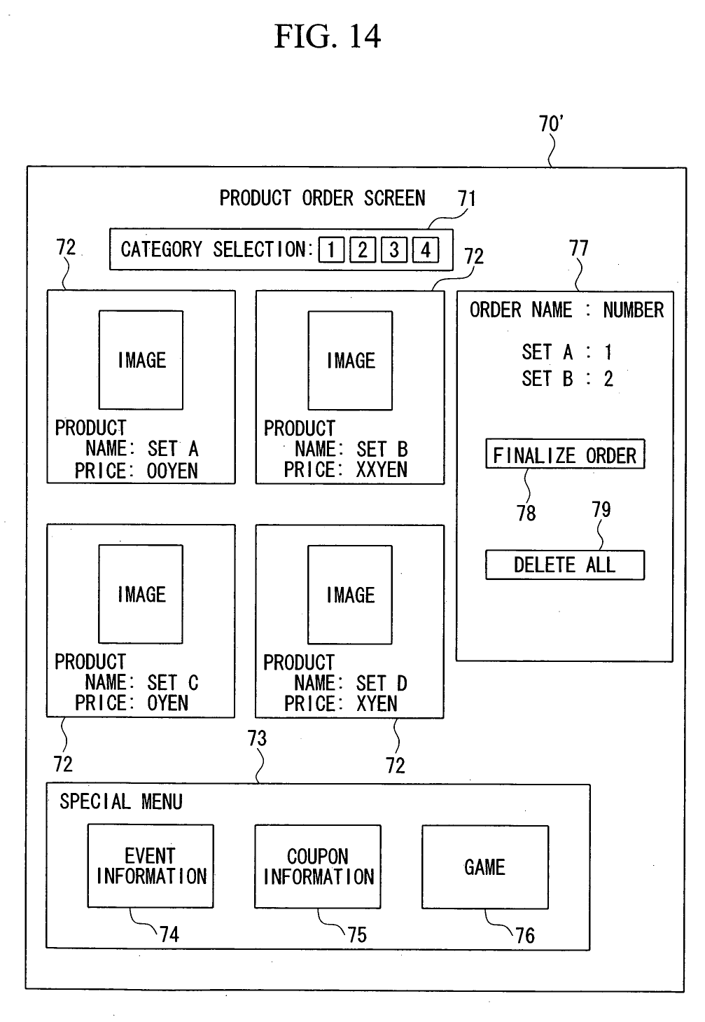

Also, it is preferable that the special menu field 73 be displayed not only on the product order screen 70, but also on screens in various statuses where users are assumed to be confabulating. Also, the contents available for selection in the special menu field 73 or on the game selection screen may be altered according to the status of the screen. “Order confirmation screen information” is template information for a screen that displays the product order screen 70′ shown in FIG. 14, which is the product order screen 70 having a further order confirmation field 77 to confirm order information, on the display section 23. Also, the order confirmation field 77 includes an “order finalizing button” 78, which finalizes the order confirmed in the order confirmation field 77 and a “cancel all button” 79, which cancels all orders confirmed in the order confirmation field 77. Also, when the underlined order product name in the order confirmation field 77 is touched, the order terminal 10 displays product detail information, which includes detailed information about the product, for the ordered product name, (contents of set A, for example), on the display section 23. “Game selection screen information” is template information for the game selection screen, which is displayed on the display section 23 when the button 76 is pressed in the special menu field 73, and which prompts the selection of the game. As described above, the screen information database 22a stores template information for various screens that are displayed on the display section 23.

Next, a configuration example of the game information storage section 22b is described with reference to the diagrams.

FIG. 5B is a diagram showing a configuration example of the game information storage section 22b of the order terminal 10 in the first embodiment of the present invention. As shown in the diagram, “game information” temporarily stores information described below as information of the game that is displayed on the display section 23. Also, the type of game is selected on the game selection screen after the button 76 is pressed. “Game program” is information relating to a program that displays the selected game on the display section 23 on the order terminal 10. “Score information” is information relating to the score of the game being played by the user and the scores of previous games. “Advertising information” is information relating to the advertising image exposed on the display section 23 as the character of the game, being information described below. “Used advertising image code” is information relating to an “advertising image code” that identifies the advertising image used as the character for the game. “Advertising image data” is image data of the advertising image that is identified by the “advertising image code”. “Exposure count” is information relating to a count number that counts how many times an advertising image identified by the respective “advertising image code” is displayed as the character during the game.

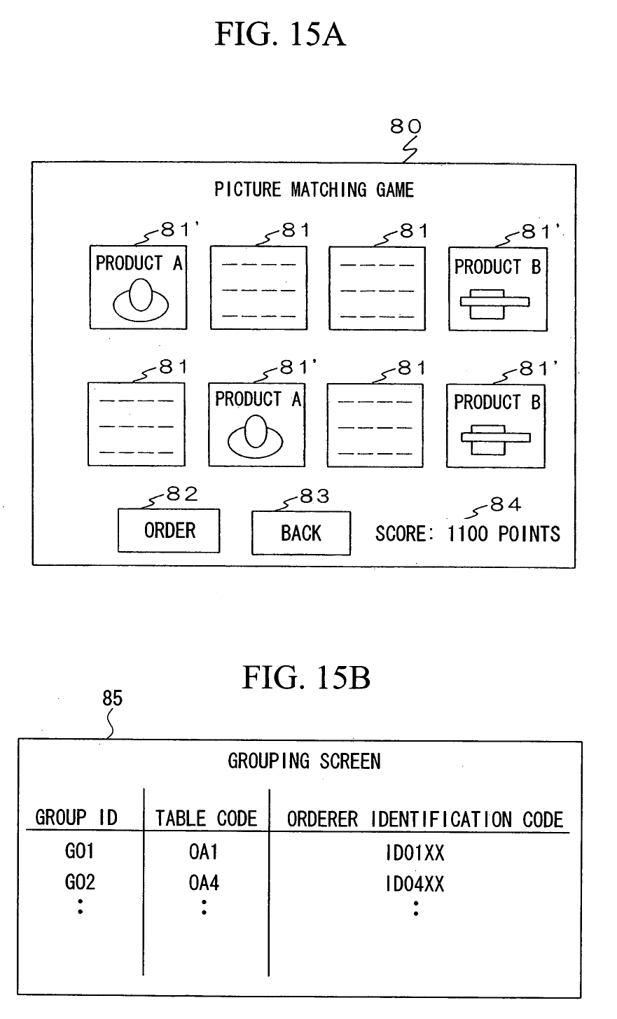

Next, reference symbol 25 denotes an input processing section that includes a touch panel provided on the display screen of the display section 23 and carries out input processing according to the screen displayed. When the game is played, the user operates the game through this touch panel. Reference symbol 27 denotes a screen control section that controls the screen that is displayed on the display section 23, making reference to the template information for screens on the screen information database 22b. Reference symbol 28 denotes a group information input section that displays, on the display section 23, the grouping screen 85 shown in FIG. 15B that inputs the group information, associating a plurality of orderer identification codes by a group ID that identifies a group with a separate account. A staff member carries out the process of assigning the predetermined group ID to the orderer identification code on this grouping screen 85.

Furthermore, the method for grouping orderer identification codes is not limited to that mentioned above. For example, there are methods for assigning a common group ID to the orderer identification code such as switching the order terminal 10 into group mode, and then, by swiping a plurality of magnetic cards that have the orderer identification codes of those who wish to become a group through the identification information retrieval processing section 26, assigning a common group ID to the identification codes. Also, the game control section 16 may provide a multi-player game between the order terminals 10 operated by users considered as a group according to the group information. Furthermore, the game control section 16 may control the same advertising image to be used as the game character for users associated as a group.

Reference symbol 29 denotes a game processing section that retrieves, from the game control section 16 and the game information storage section 22b, information related to the game selected on the game selection screen, and that outputs the game video image to the display section 23 and the sound to the sound production section 24. As a specific example, the process in the case when “picture matching game” is selected on the game selection screen is described below. The game processing section 29 carries out the process of displaying on the display section 23, the game screen 80 shown in FIG. 15A for example.

FIG. 15A is a diagram showing an example of the game screen 80 that is displayed on the display section 23 in the first embodiment of the present invention. The game of the game screen 80 is a game that is carried out in a similar manner to the memory game, in which four pairs of the same advertising images are prepared on the back of eight cards, and when two cards having the same advertising images are consecutively turned up they are held to be correct. As shown in the diagram, the cards 81′ (hereinafter referred to as advertising image 81′) having advertising images of “product A” and “product B” have already been correctly solved and four cards have been turned up. Also, if any two cards 81 are consecutively turned up from remaining four cards that have not been turned up, they are held to be correct if they are the same advertising image.

Moreover, the user can place an order for the product advertised on the advertising image 81′ by specifying the advertising image 81′ and pressing an order button 82 (order detection device). Also, when the “picture matching game” is desired to end, a back button 83 may be pressed. Moreover, the game processing section 29 processes the input information that is inputted from the input processing section 25 according to the course of the game and outputs the result to the display section 23 and the sound production section 24. Furthermore, the game processing section 29 displays the score, computed using a predetermined formula according to the course of the game, in a score display area 84.

Reference symbol 2A denotes an exposure count section that counts how many times (“exposure count”) the advertising image is displayed as a game character on the display section 23, and that associates the exposure count with an “advertising image code” that identifies the advertising image, and stores it in the game information storage section 22b. On the above mentioned game screen 80, the exposure count section 2A separately counts, according to the advertising contents of the advertising image 81′, how many times the advertising image 81′ is displayed as the user turns up the cards 81. As described above, the order terminal 10 is capable of retrieving necessary information from the product order management device 12 and the database 22, and then providing the product order screen 70 and the game screen 80 to the user on the display section 23.

Also, the game control section 16 controls the game screen 80 to include the order button 82 after the user specifies the advertising image 81′. Thus, the advertising system can carry out ordering of the product of the advertising image 81′ as the user specifies the advertising image 81′ at any given timing and presses the order button 82. The details of this order processing operation will be described later.

Next, the internal structure of the product order management device 12 is described with reference to the diagrams.

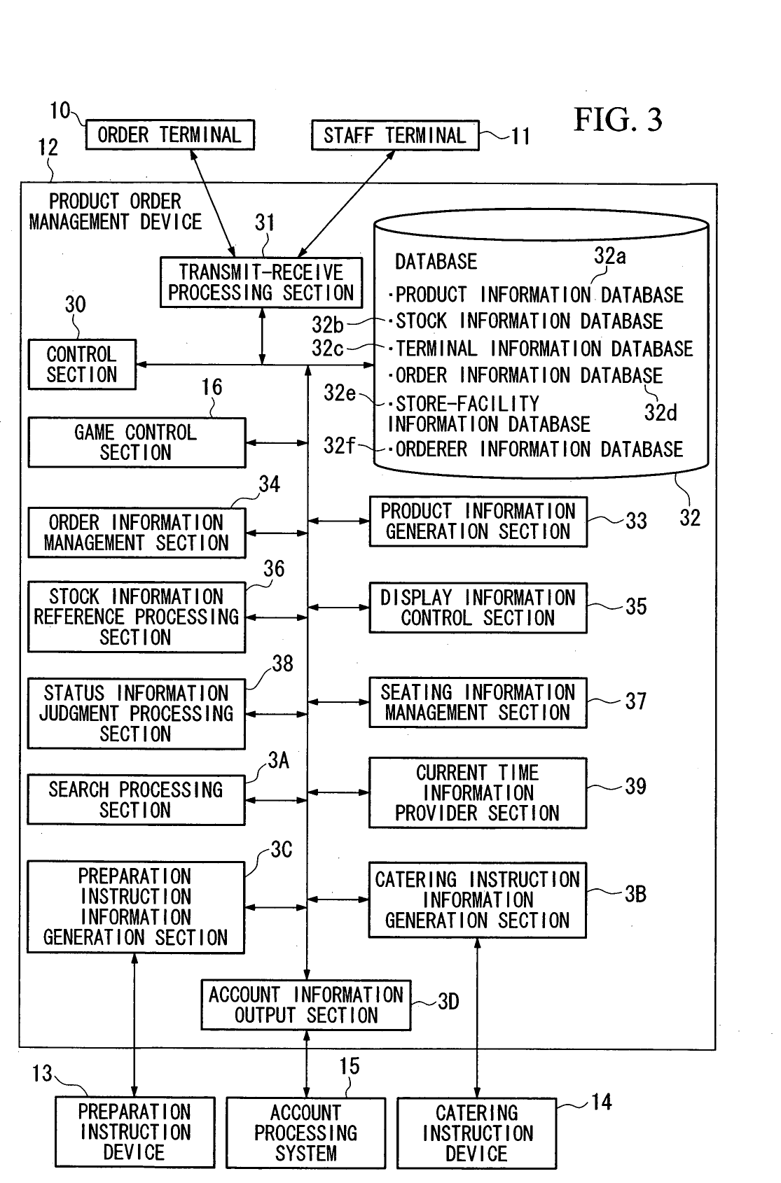

FIG. 3 is a diagram showing a schematic construction of a product order management device 12 of the advertising system in the first embodiment of the present invention. In this diagram, reference symbol 30 denotes a control section that controls the data in the product order management device 12. Reference symbol 31 denotes a transmit-receive processing section that transmits and receives various kinds of information to and from the order terminal 10 and the staff terminal 11. Reference symbol 32 denotes a database that stores information to manage, information displayed on the order terminal 10 and order information. In the selection of the advertising image to be used as the game character, the game control section 16 makes use of various information stored in the database 32 and carries out a process of selection and so on of the product advertising image that will further improve advertising effectiveness according to history and past experience.

The database 32 has a product information database 32a, which stores information relating to the products that are available for order; a stock information database 32b, which stores information relating to stocks of those products; a terminal information database 32c, which stores information relating to the association between the order terminals 10 and table codes; an order information database 32d, which stores information relating to the order information associated with the orderer identification code; a store-facility information database 32e, which stores information relating to various stores and facilities; and an orderer information database 32f that associates information of an orderer with the orderer identification code and stores it. Configuration examples of above mentioned six databases are described below.

Firstly, the product information database 32a is described with reference to the diagrams.

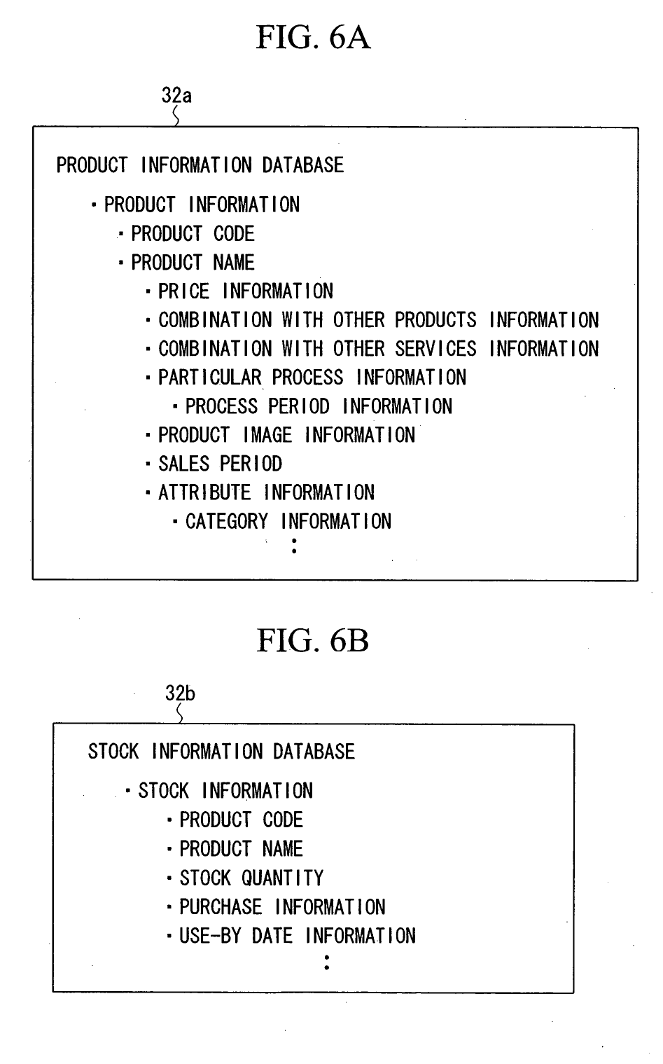

FIG. 6A is a diagram showing a configuration example of the product information database 32a of the product order management device 12 in the first embodiment of the present invention. As shown in the diagram, information described below are stored as the “product information”. “Product code” is an identifier that identifies a product. “Product name” is a name of the product that is identified by the “product code”. “Price information” is information relating to a product price that is identified by the “product code”. “Combination with other products information” is information relating to the combination when a product is sold in combination with other products. The combination with a product refers to the information relating to the combination when a plurality of products is sold in sets. “Combination with other services information” is information to distinguish whether or not the product identified by the “product code” is one for which a complimentary item is offered, such as, one extra juice can be ordered free of charge if the total price of the order exceeds certain amount. “Particular process information” is information that defines a particular process for a limited period such as, the product identified by the “product code” is half-price or added to a set A free of charge only during a period predefined by the “process period information”.

“Product image information” is information relating to the image data of the product identified by the “product code”. “Sales period” is information relating to the sales period of the product identified by the “product code”. “Attribute information” is the following information relating to the attributes of the product identified by the “product code”. “Category information” is information relating to the category of the product identified by the “product code” (such as Japanese meals, Western meals, desserts, and drinks). There is other “attribute information” such as information relating to the number of people the meal serves. Furthermore, the different information may be managed on dedicated databases; for example, the “product image information” may be managed on a dedicated database.

Next, the stock information database 32b is described with reference to the diagrams.

FIG. 6B is a diagram showing a configuration example of the stock information database 32b of the product order management device 12 in the first embodiment of the present invention. As shown in the diagram, it stores the information described below as “stock information”. “Product code” is an identifier that identifies a product. “Product name” is the name of the product specified by the “product code”. “Stock quantity” is information relating to the stock quantity of the product identified by the “product code”. “Purchase information” is information of the purchase dates and purchase prices of the product identified by the “product code”. “Purchase information” also includes information relating to an average purchase price that is an average of the purchase price throughout a predefined period in the past. “Use-by date information” is information relating to the use-by date of the product, which is computed according to the purchase date of the “purchase information” and the respective period for which each product can be preserved (or usable period).

Next, the terminal information database 32c is described with reference to the diagrams.

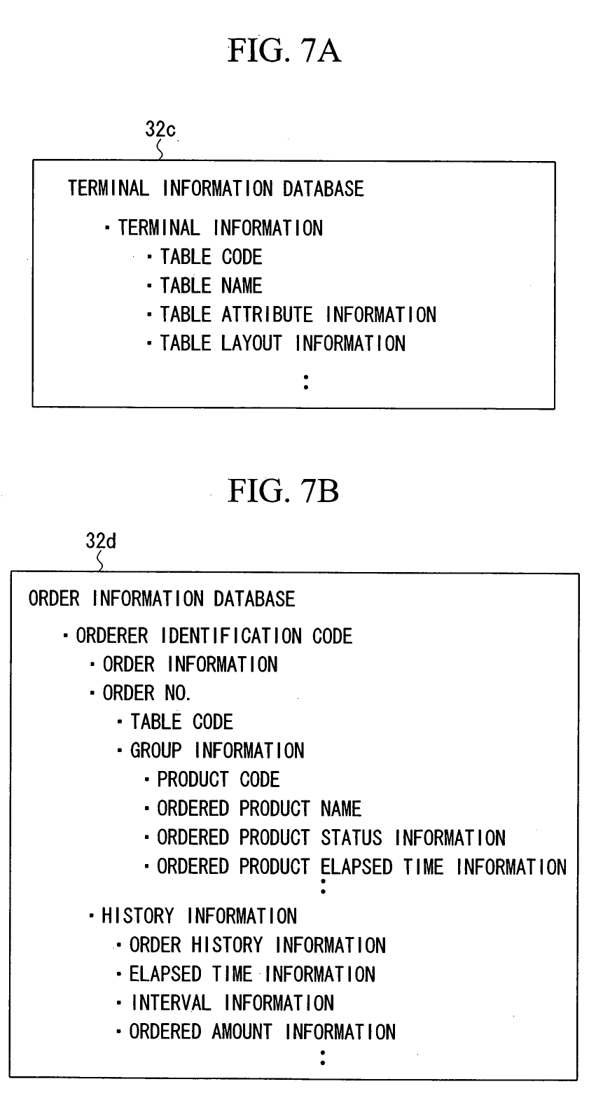

FIG. 7A is a diagram showing a configuration example of the terminal information database 32c of the product order management device 12 in the first embodiment of the present invention. As shown in the diagram, it stores the information described below as “terminal information”. “Table code” is an identifier, which identifies the table and the order terminal 10 provided on the table. “Table name” is a unique name for each table that is assigned in order for the staff to distinguish each table. Also, if the table is a counter style, the “table code” and the “table name” may be assigned by delimiting the counter at any given interval.

Also, “table attribute information” is information relating to attributes such as; a table category (counter style, round table style, parlor style, etc.) identified by the “table code”, facility information (information relating to the order terminal provided, information about whether or not a hot plate is installed on the table and so forth), smoking or non-smoking, and so forth. “Table layout information” is information relating to the installation location of the table identified by the “table code”. As described above, the terminal information database 32c also stores information of the table as information of the order terminal 10, since the order terminals 10 are associated with the tables one-to-one.

Next, the order information database 32d is described with reference to the diagrams.

FIG. 7B is a diagram showing a configuration example of the order information database 32d of the product order management device 12 in the first embodiment of the present invention. As shown in the diagram, it stores the information indicated below as “order information”, associating it with the “orderer identification code” that identifies the orderer who placed the order. “Order No.” is a number that is randomly assigned by the order information management section 34 to identify the order. “Table code” is an identifier that identifies the table where the orderer identified by the “orderer identification code” is seated. “Group information” is information that includes a group ID that identifies a group when the orderer identified by the “orderer identification code” belongs to the group having a separate account. “Product code” is an identifier that identifies the ordered product in the order identified by the “order No.”. “Ordered product name” is the name of the ordered product identified by the “product code”. “Ordered product status information” is information that indicates the status (not prepared, preparation in progress, preparation complete, catered, etc.) of the ordered product identified by the “order No.” and the “product code”. “Ordered product elapsed time information” is information that indicates the time elapsed since the order identified by the “order No.” and the “product code” was placed.

“History information” includes the following information as history information for a series of orders placed by the orderer identified by the “orderer identification code”. “Order history information” is information relating to the history of the series of orders placed by the orderer identified by the “orderer identification code”. “Elapsed time information” is information relating to the elapsed time since the series of orders placed by the orderer identified by the “orderer identification code” commenced. “Interval information” is information of the intervals of the series of orders placed by the orderer identified by the “orderer identification code”. “Order amount information” is information relating to the total charge for the products of the series of orders placed by the orderer identified by the “orderer identification code”. As described above, the order information database 32d stores the order information of the ordered products.

Next, the store-facility information database 32e is described with reference to the diagrams.

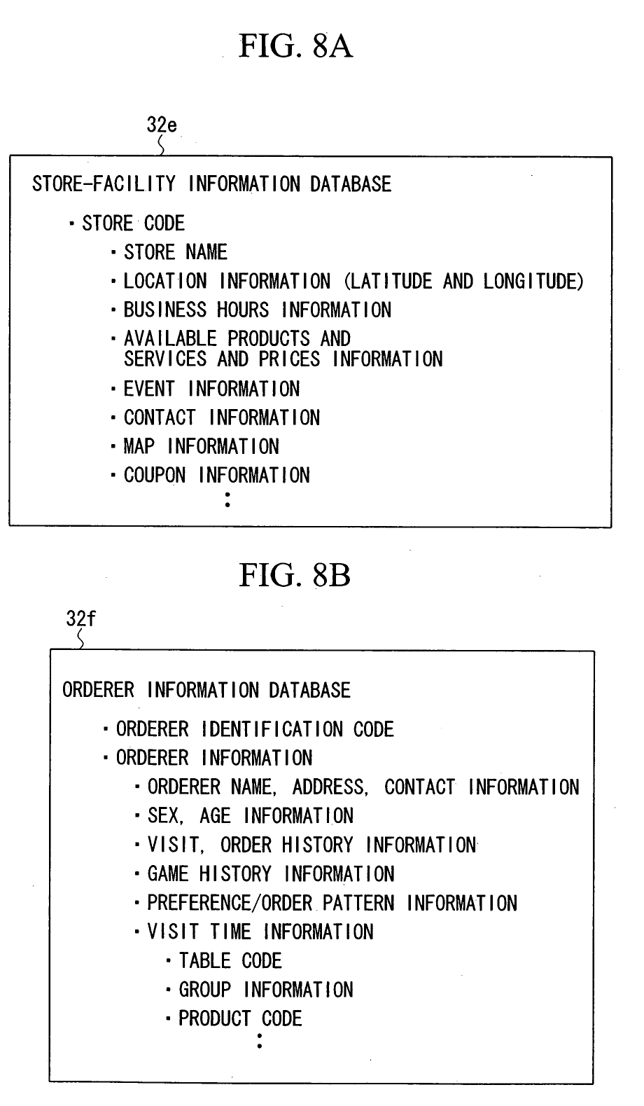

FIG. 8A is a diagram showing a configuration example of the store-facility information database 32e of the commodity order management device 12 in the first embodiment of the present invention. As shown in the diagram, it stores the following information relating to the store or facility, associating it with a “store code” that identifies a store or facility. “Store name” is the name of the store or facility identified by the “store code”. “Location information” is information of the location of the store or facility identified by the longitude and latitude. “Business hour information” is information relating to the business hours (or available hours) and holiday days of the store or facility identified by the “store code”.

“Available products and services and prices information” is information (including price information) relating to products or services available at the store or facility identified by the “store code”. “Event information” is information relating to events held at the store or facility identified by the “store code”. “Contact information” is information relating to the contact details of the store or facility identified by the “store code”, such as telephone number, facsimile number and e-mail address. “Map information” is information relating to the neighborhood map of the store or facility identified by the “store code”. “Coupon information” is discount information relating to coupon tickets and so on that can be used at the store or facility identified by the “store code”.

Next, the orderer information database 32f is described with reference to the diagrams.

FIG. 8B is a diagram showing a configuration example of the orderer information database 32f of the product order management device 12 in the first embodiment of the present invention. As shown in the diagram, it stores the information indicated below as the “orderer information”, which is information relating to the orderer, associating it with the “orderer identification code” that identifies the orderer who placed the order. “Orderer's name, address, and contact information” is information relating to the name, address and contact details of the orderer identified by the “orderer identification code”. “Gender and age information” is information relating to the gender and age of the orderer identified by the “orderer identification code”.

“Visit and order history information” is information relating to the history of the orderer's past visits, and to the history of the products ordered when visited by the orderer identified by the “orderer identification code”. “Game history information” is information such as the game type, time played, and score that the orderer identified by the “orderer identification code” played in the past, and the history of orders from the advertising information displayed during the game. “Preference and ordering pattern information” is information of orderer's product preference and frequent ordering pattern sampled from the “visit and order history information”. “Visit time information” stores the information described below as information that accumulates in real time when the orderer identified by the “orderer identification code” visits. “Table code” is an identifier that identifies the table where the user is seated. “Group information” is information that identifies the group when the orderer is a group. “Product code” is an identifier that identifies the product ordered by the orderer.

Here, we return to the description of the internal structure of the product order management device 12. Reference symbol 33 denotes a product information generation section that references the product information on the product information database 32a and generates the product display field 72 included on the product order screen 70 shown in FIG. 13 on the display section 23 of the order terminal 10. Reference symbol 34 denotes an order information management section that associates the order information that the order terminal 10 retrieves with the orderer identification code that the identification information retrieval processing section 26 of the order terminal 10 retrieves, and manages them. Also, the order information that the order terminal retrieves includes orders placed when the order button 82 is pressed after the product image 81′ displayed as a character during the game has been selected.

Reference symbol 35 denotes a display information control section that changes the contents (product display field 72) of the product order screen 70 displayed on the display section 23 with arbitrary timing, by controlling the product information generation section 33.

Furthermore, the screen whose contents the display information control section 35 changes is not limited to the product order screen 70, and the contents of various screens displayed on the display section 23 may be changed. Also, although the product information generation section 33, the display information control section 35 and the screen control section 27 in the order terminal 10 generate the product order screen 70, the assignment of the generation process of the product order screen 70 according to various kinds of information may be decided in consideration of the communication ability and processing power of the product order management device 12 and the order terminal 10.

Also, although the game control section 16 and the game processing section 29 in the order terminal 10 generate the game screen, assigning this process may be carried out in the same manner as the process of the product order screen 70. For example, when the processing power and communication speed of the product order management device 12 are high, everything relating to the game screen is processed by the game control section 16, and the game processing section 29 displays the received game screen directly on the display section 23. Conversely, when the processing power of the order terminal 10 is high, the order terminal 10 downloads the game program from the product order management device 12, and the game processing section 29 may carry out almost all processes relating to the game screen according to the game program.

Moreover, although it is not shown in the diagram, the order information management section 34 has a temporary order information storage section that stores temporary order information, being the information in the stage where the order is selected before pressing the “order finalizing button” 78 that finalizes the order confirmed in the order confirmation field 77 on the product order screen 70′. Furthermore, the product order management device 12 may change the screen to the product order screen 70 for ordering the product of the selected advertising image 81′when the order button 82 is depressed on the game screen 80.

Reference symbol 36 denotes a stock information reference processing section that, when the product information generation section 33 generates the product display field 72 for the product order screen, prevents products that are out of stock from being selected on the product order screen 70 according to stock information referenced on the stock information database 32b. Also, if the display information control section 35 changes the contents of the product order screen 70, the stock information reference processing section requests the display information control section 35 to preferentially display overstocked products. Reference symbol 37 denotes a seating information management section that manages seating information including information in which the table code that distinguishes between the table having the order terminal 10 installed and the order terminal 10, is associated with the orderer identification code of the orderer seated at the table.

Here, the seating information management section 37 is described in further detail.

The seating information management section 37 has a seating information generation section that generates seating information in which the table code of the table is associated with the orderer identification code, every time the identification information retrieval processing section 26 of the order terminal 10 installed on the table retrieves an orderer identification code. Also, the seating information management section 37 has a seating information database that stores the seating information in which the table code is associated with the orderer identification code.

Next, a configuration example of the seating information database is described.

The seating information database stores the information described below as “seating information”. “Table code” is an identifier that identifies a table. “Orderer identification code” is information that identifies the orderer being seated at the table identified by the “table code”. “Seating information generated time” is information relating to the time when the seating information generation section generated the “seating information” in which the “table code” and the “orderer identification code” are associated. Also, “group information” and “order information” are as mentioned above. “Seating history information” is past history information that is updated due to the movement when an orderer identified by the “orderer identification code” moves to another table.

Furthermore, the seating information management section 37 has a seating information update processing section that updates the seating information to the latest on the seating information database according to the “seating information generated time” when a plurality of seating information including the same orderer identification code are present. Also, the seating information update processing section stores the non-latest seating information stored in the seating information database into the seating information database as “seating history information”. As described above, the seating information management section 37 manages the latest seating information and the history of seating information.

Reference symbol 38 denotes a status information judgment processing section that refers to the “order history information”, the “elapsed time information”, the “interval information” and the “order amount information” in the order information database 32d and judges status information, which is information relating to the order status of the orderer, (for example, waiting for orders placed, having appetizer, having main course, having desert, etc.). Also, the display information control section 35 changes the contents of the product order screen 70 according to the status information judged by the status information judgment processing section 38. Furthermore, the game control section 16 also changes the contents of the advertising images 81′ displayed in the game screen 80, according to the status information judged by the status information judgment processing section 38.

Reference symbol 39 denotes a current time information provider section that provides current time information, which is time information relating to the season, date, day of the week and time of day. Also, the display information control section 38 searches on the product information database 32a for “particular process information” that includes “process period information” within whose period the “current time information” provided by the current time information provider section falls, and changes the contents of the product order screen 70 to reflect the process that the searched “particular process information” defines. Correspondingly, the game control section 16 searches on the product information database 32a for “particular process information” that includes “process period information” within whose period the “current time information” provided by the current time information provider section falls, and changes the contents of the advertising image 81′ displayed on the game screen 80 to reflect the process that the searched “particular process information” defines.

Reference symbol 3A denotes a search processing section that searches for neighborhood information, which is information relating to other stores or facilities located near the store, on the store-facility information database 32e according to the location information of the store in which the order terminal 10 is installed. Also, the display information control section 35 is able to let the neighborhood information that the search processing section 3A searched, appear on the product order screen 70 and various screens. Furthermore, the game control section 16 is also able to let the neighborhood information that the search processing section 3A searched, appear as advertising images on the game screen 80.

Reference symbol 3B denotes a catering instruction information generation section that makes reference to the “seating information” on the seating information database 37b at the point of completion of preparation according to the orderer identification code associated with the “order information” of the food and drink that has been prepared, and generates catering instruction information for the catering instruction device 14 to carry out catering instructions. Reference symbol 3C denotes a preparation instruction information generation section that generates preparation instruction information for the preparation instruction device 13 to carry out preparation instructions according to the “order information” that the order information management section 34 manages.

Reference symbol 3D denotes an account information output section that, in response to a request of the account processing system 15,brings together the “order information” associated with the orderer identification code or the “order information” associated with the “group information” and outputs it as account information. Also, the account information output section 3D further retrieves information relating to the game result from the game control section 16 when discount service is offered to the high scorer of a game, or when the contribution at accounting time is to be differentiated according to the result of a game held between groups.

Also, the display information control section 35 is able to refer to the “order charge information” on the order information database 32d, and when an additional order is placed and the total charge of the order exceeds a predefined amount, display on the display section 23, a product order screen 70 that includes total charge service information, which is information relating to complimentary items that can be assigned to the orderer. Also, the display information control section 35 is able to make use of the “orderer information” referenced on the orderer information database 32f according to the orderer identification code, and display a product order screen 70 that includes information relating to products of the orderer's preference on the display section 23.

Here, one embodiment of the internal structure of the game control section 16 is described.

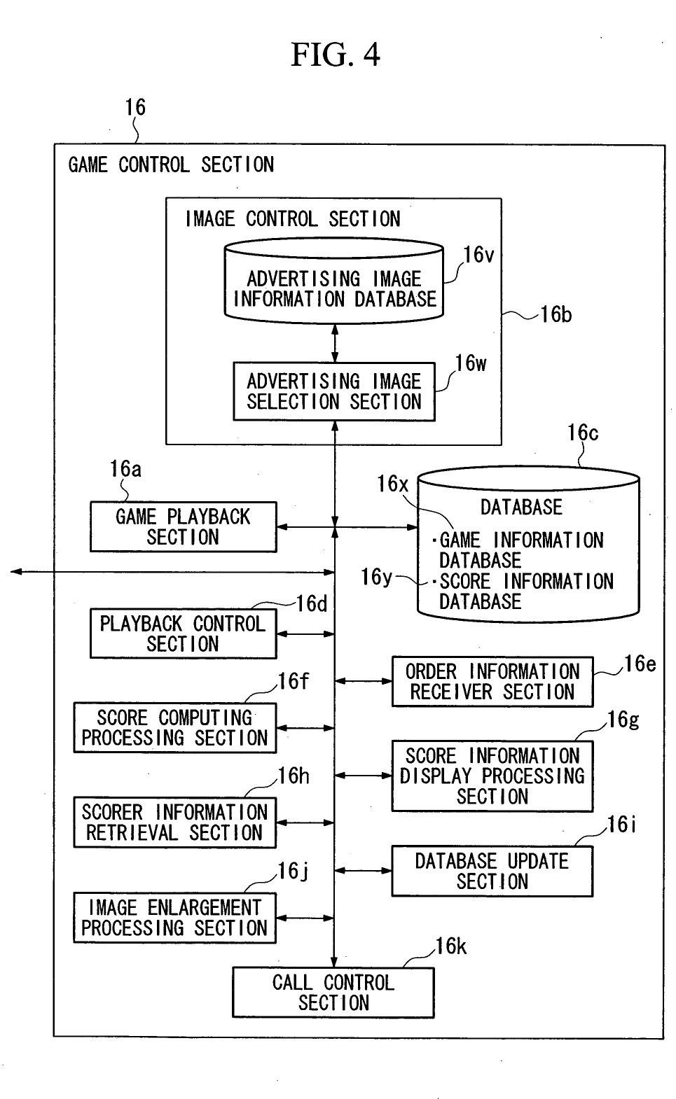

FIG. 4 is a block diagram showing the internal structure of the game control section 16 of the commodity order management device 12 in the first embodiment of the present invention. In the diagram, reference symbol 16a denotes a game playback section (game playback device) that provides the game screen 80 for the display section 23 of the order terminal 10. Reference symbol 16b denotes an image control processing section that controls the game playback section 16a to use the advertising image 81′, being an image for advertising products or services, as the character image that is used on the game screen 80.

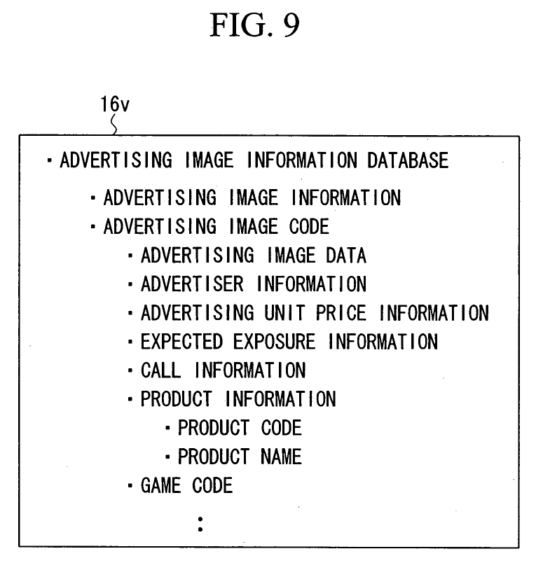

Next, the internal structure of the image control processing section 16b is described. As shown in FIG. 4, the image control processing section 16b has an advertising image information database 16v that stores the advertising image information, which is information relating to the product or service, including the “advertising image data”, which is electronic data of the advertising image 81′. Here, a configuration example of the advertising image information database 16v is described with reference to the diagrams. FIG. 9 is a diagram showing a configuration example of the advertising image information database 16v of the game control section 16 in the first embodiment of the present invention. As shown in the diagram, it stores “advertising image information” including “advertising image data”, associating it with the “advertising image code” that identifies the “advertising image data”.

The “advertising image data” is image data to be displayed as the character of the game, and also for advertising products and services. According to the mode of the game, either a still image or a motion picture may be employed for this “advertising image data”. “Advertiser information” is information relating to the advertiser who requests advertising. “Advertising unit price information” is information relating to the advertising unit price charged for every exposure when charging by “exposure count”. Also, apart from the “exposure count”, the charging method may also be a method whereby the charge is according to the amount of time that the advertising image is displayed. When charging by time, the “advertising unit price information” is information relating to the advertising unit price charged per unit time. “Expected exposure information” is information that specifies the number of times (amount of time if charging by time) that the advertiser identified by the “advertiser information” desires that the advertising be exposed during a set time period.

“Call information” is information relating to the sound or music that is called up by the sound production section 24 in response to the “advertising image” displayed on the display section 23. “Product code” is an identifier that identifies the product mentioned above, and that identifies the product type displayed as an advertising image by the “advertising image data” on the display section 23. Also, when form or format types of the image are different depending on the type of game, the “advertising image data” stored in the advertising image information database 16v may be associated with a “game code” that identifies the game type. That is, a plurality of “advertising image data” of the same product is stored separated according to the “game code”.

Also, the image control processing section 16b has an advertising image selection section 16w that makes reference to information on the database 32, such as information relating to the store in which the order terminal 10 is installed, period of time, date, day of the week, and time elapsed since the user of the order terminal 10 was seated, and selects advertising images 81′ of products that have potential to advertise more effectively from the advertising image information database 16v. Furthermore, the advertising image selection section 16w may specify the product having high advertising effectiveness based on the information outputted by the seating information management section 37, the status information judgment processing section 3, the search processing section 3A and so forth, and select the advertising image 81′ of the product.

Reference symbol 16c denotes a database that stores information relating to the game that the game control section 16 processes. As shown in FIG. 4, the database 16c has a game information database 16x that stores the game information, which is information relating to the game such as the “game program”, which is a program to execute the game; and a score information database 16y that stores score information, which is information relating to the highest score that the user recorded in each game in the past. Here, the configuration examples of the game information database 16x and the score information database 16y are described with reference to the diagrams.

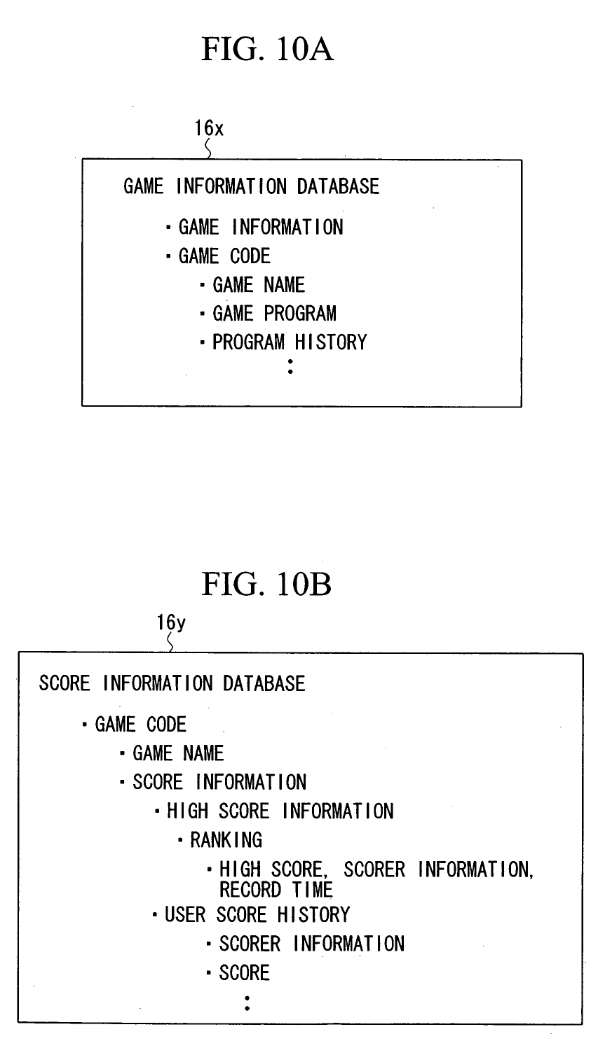

Firstly, the configuration example of the game information database 16x is described with reference to the diagrams. FIG. 10A is a diagram showing a configuration example of the game information database 16x of the game control section 16 in the first embodiment of the present invention. As shown in the diagram, it stores the information described below as “game information”. “Game code” is an identifier that identifies the type of game. “Game name” is the name of the game identified by the “game code”. “Game program” is a program for the game identified by the “game code” to be executed on a computer. “Program history” is information relating to the history of version upgrades or fixes of the “game program”.

Next, a configuration example of the score information database 16y is described with reference to the diagrams.

FIG. 10B is a diagram showing a configuration example of the score information database 16y of the game control section 16 in the first embodiment of the present invention. As shown in the diagram, it associates the “score information” of the game identified by the “game code” with the “game code” and stores it. “Game name” is the name of the game identified by the “game code”. Also, the “score information” includes the information described below. “Highest scores information” is information relating to the highest scores that become top “rank” up to a predefined number.

As shown in the diagram, associating them with the “rank”, it stores information such as “top scores”, which are the high scores that become “rank” among past scores, “scorer information”, which is information that identifies the user who recorded the “top score”, and “recorded time”, which is information relating to the date and time when the “top score” was recorded. “User score history” is information relating to the “score” previously recorded by the user identified by the “scorer information” in the game identified by the “game code” of a particular user. Also, the aforementioned “orderer identification code” may be used for the “scorer information”, and a random character string entered when the user records a high score, may be used.

Next, we return to the description of the internal structure of the image control processing section 16b.

Reference symbol 16b denotes a playback control section (playback control device) that controls the game playback section 16a so as to include the order button 82 that detects an order of a product or service displayed as a character image in the game screen 80. Reference symbol 16e denotes an order information receiver section (order information receiver device) that receives the order information that is detected when the user selects the advertising image 81′ and the order button 82 is pressed, and that is for ordering the product of the advertising image 81′ from the order terminal 10. Reference symbol 16f denotes a score computing processing section (score computing device) that computes the score using a predefined formula according to the progress of the game. Here, the score that the score computing processing section 16f computes is taken as the “computed score”.

Reference symbol 16g denotes a score information display processing section (score information display device) that associates the “top score” and the “scorer information”, from the “top score information” referenced on the score information database 16y, and displays them on the display section 23. Reference symbol 16h denotes a scorer information retrieval section (scorer information retrieval device) that prompts the user to input a random character string that becomes the “scorer information”, and retrieves the “scorer information” of users who recorded high scores. Also, the scorer information retrieval section 16h may retrieve as “scorer information” the “user identification code” which identifies the user. Reference symbol 16i denotes a database update section (database update device) that associates the “computed score” with the “scorer information” that the scorer information retrieval section 16h retrieves, and stores it as a new “top score” in the score information database 16y.

Reference symbol 16j denotes an image enlargement processing section (image enlargement device) that displays an enlarged advertising image, being an enlargement of the advertising image, on the display section 23 according to the “advertising image data”. For the enlarged advertising image that the image enlargement processing section 16j displays on the display section 23, when the image control processing section 16b displays the advertising image reduced to a predefined proportion (%), the full sized “advertising image data” (or at smaller proportion) displayed is treated as the enlarged advertising image. Reference symbol 16k denotes a call control section (call control device) that refers to the “call information” included in the “advertising image information” on the advertising image information database 16v, and controls the sound production section 24 to call information relating to the product.

As shown above, the game control section 16 controls the game screen 80 that is displayed on the display section 23 and the sound that the sound production section 24 calls. Also, the product order management device 12 carries out the management of the “order information”, and the game control section 16 makes use of this order management information to further improve advertising effectiveness by timely changing of the advertising image 81′ used as a character on the game screen 80 displayed on the display section 23 of the order terminal 10, and the sound called by the sound production section 24.

The order terminal 10 is not limited to a configuration where the identification information retrieval processing section 26 is built in, and a configuration where a separate user identification processing section is provided and the user identification processing section is connected to the order terminal 10 is also possible. Also, in the embodiment described above, although order management including preparation of food and drink for orders of food and drink has been described, it is not limited to this, and an embodiment in which the “food and drink” is replaced with various “products” and the “preparation” replaced with “product provision preparation” is also possible.

Also, although in the embodiment described above a method using a magnetic card and a reader device that reads the magnetic card (identification information retrieval processing section 26) has been described as the method for retrieving the orderer identification code, it is not limited to this, and various methods that retrieve information to identify the orderer such as a method using an IC card having a non-contact readable and writable recording media built-in and a reader device to read the information in the IC card, or a method using a card having a barcode printed on it and a reader device to read the barcode may be preferably employed.

Also, each of the processing sections in FIG. 2, FIG. 3 and FIG. 4 mentioned above may be realized by dedicated hardware, or, each of the processing sections may be constructed from a memory and a CPU (central processing unit), and may realize their functions by loading programs that realize the functions of each processing section into the memories and executing them.

Also, the memory mentioned above is taken as being configured with a hard disk device or magnetic optical disk device, or non-volatile memory such as flash memory, or read-only recording media such as a CD-ROM, or volatile memory such as RAM (random access memory), or with a combination of these recording medias that are computer readable and writable.

Next the management method of the order information of the product order management device 12 of the advertising system mentioned above, and the selection method that selects the advertising image that is a game character, according to the managed order information are described.

Here, it is assumed that the user is holding a magnetic card having the orderer identification code that identifies the user as an orderer recorded thereon. A predetermined number of magnetic cards may be created beforehand, and the advertising system may further have a magnetic card creating device, and a magnetic card having the recorded orderer identification code may be created using the magnetic card creating device.

Next, the user is seated at the table and swipes the distributed magnetic card through the identification information retrieval processing section 26 of the order terminal 10 provided at the table. Thus, the identification information retrieval processing section 26 retrieves the orderer identification code that identifies the user.

Then, the order terminal 10 transmits a request for the product information including the retrieved orderer identification code to the product order management device 12. Thus, a transmit-receive processing section 31 receives the orderer identification code and the product information.

Next, the display information control section 35 identifies the product of the orderer's preference according to the “orderer information” referenced on the orderer information database 32f according to the orderer identification code, and controls the product information generation section 33, and refers to the product information of the product identified on the product information database 32a and generates the product display field 72 that includes the product information, and that is included on the product order screen 70. Then, the transmit-receive processing section 31 transmits the product display field 72 generated by the product information generation section 33 to the order terminal 10. Thus, the transmit-receive processing section 21 of the order terminal 10 receives the product display field 72.

Next, the screen control section 27 displays the product order screen 70 on the display section 23 according to the received product display field 72 and the “order screen information” referenced on the screen information database 22a. As described above, a product order screen 70 including the products that reflect the orderer's preference can be displayed on the display section 23 under the control of the display information control section 35. Also, in the game control section 16, the advertising image selection section 16w can select as game characters advertising images of the products that reflect the orderer's preference referenced on the orderer information database 32f.

At this point, when the product information generation section 33 generates the screen information for the product order screen 70, the stock information reference processing section 36 prevents non-stocked product from being selected on the product order screen 70 according to the stock information referenced on the stock information database 32b. Also, the stock information reference processing section 36 requests the display information control section 35 to display over-stocked products preferentially. Thus, the display information control section 35 controls the product order screen 70 to display most preferentially products that are of the orderer's preference and that are over-stocked. Also, when the advertising image selection section 16w selects the advertising image too, it references the stock information on the stock information database 32b, and can select an advertising image for which the stock information has been taken into account as the game character.

Also, at the point when the user is seated at the table, the staff member carries out the grouping process as necessary. At this point, the group information input section 28 associates a plurality of orderer identification codes with a group ID that identifies a group with a separate account, and displays the grouping screen 85 shown in FIG. 15B onto which the group information is inputted, on the display section 23. At this point, the display information control section 35 can refer to the “attribute information” and prioritize products suitable for a group, or refer to the “orderer information” and prioritize products for which there is the greatest overlap among the preferences of each orderer, and display product information on the display section 23. Thus, the advertising image selection section 16w can select a product suitable for the group for the advertising image. Furthermore, the game control section 16 can provide a multi-player game to be played between groups.

Next, when a product is selected on the product order screen 70 displayed on the order terminal 10, the screen control section 27 displays a list of selected products in the order confirmation field 77 as shown in the product order screen 70′. At this point, the order information management section 34 stores the information relating to the selected product as temporary order information in the temporary order information storage section. Here, when the user places the order of the selected products, the order is finalized on the order terminal 10 by pressing the “order finalizing button” 78 on the product order screen 70′. Also, when the user decides not to order the selected products, it returns to the product order screen 70 by pressing the “cancel all button” 79.

Next, the screen control section 27 displays on the display section 23 a screen that prompts the user to insert their magnetic card into the identification information retrieval processing section 26 to finalize the order. Here, when the magnetic card is swiped, the stock information reference processing section 36 references the stock information database 32b with regard to the stock availability of the products included in the “order information”. Here, if the requested products are in stock, then it proceeds to the product order process. Also, if a requested product is not in stock, then it is reported to the order terminal 10.

Next, the preparation instruction information generation section 3C generates preparation instruction information for the preparation instruction device 13 to carry out preparation instructions, according to the “order information” that the order information management section 34 manages. Then, the preparation instruction device 13 receives the generated preparation instruction information and displays the preparation instruction screen 50. Then, it reports to the order terminal 10 that the above mentioned order is received. The processes described above are carried out every time an order is placed, and while no orders are being placed, the display information control section 35 updates the product order screen 70 with appropriate timing, according to the “status information” that the status information judgment processing section 38 judges. According to the above, the advertising system of the present invention displays the product order screen 70 according to the order status of the user, and can carry out sales promotion of products. Also, the advertising image selection section 16w changes the advertising image selected as the game character, with appropriate timing, to an advertising image having better advertising effectiveness according to the “status information”.

Furthermore, when the preparation according to the preparation instructions is complete, according to the orderer identification code associated with the “order information” of the prepared food and drink, the catering instruction information generation section 3B references the “seating information”, at the point of completion of preparation, on the seating information database 37b , and generates catering instruction information for the catering instruction device 14 to carry out the catering instruction. This catering instruction information is also used for the process of the status information judgment processing section 38.

According to the above, the advertising system of the present invention can make the advertising image that becomes the game character displayed on the display section 23 of the order terminal 10, one that improves advertising effectiveness, according to the information relating to the order and catering of the product that the product order management device manages.

Next, the advertising operation during the game of the above mentioned advertising system is described.

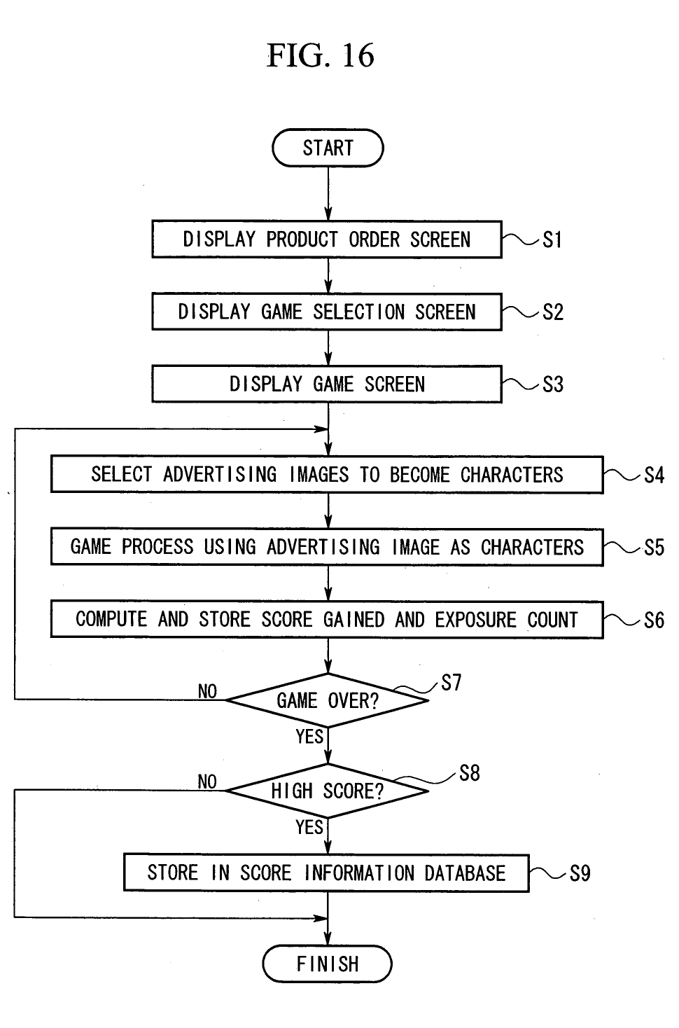

FIG. 16 is a flow diagram showing the operation in which the advertising image used as a game character is selected and displayed on the order terminal 10, in the process in which the product order management device 12 of the advertising system in the first embodiment of the present invention manages product orders.

Firstly, the procedure of transition to the game screen is that the product order management device 12 of the advertising system displays the product order screen 70 including the “special menu” 73 on the order terminal 10 (step S1). Furthermore, the procedure of transition to the game screen is not limited to that described above, and a screen including the “special menu” 73 (or a screen including the button 76) need only be displayed on the display section 23. Next, the screen control section 27 of the order terminal 10 displays the game selection screen on the display section 23, according to the control information from the game control section 16 and the “game selection screen information” referenced on the screen information database 22a (step S2). Here, it is assumed that the user has selected the “picture matching game”.

Next, the game control section 16 reads the “game program” from the game information database 16x and executes it. Thus, the game playback section 16a controls the game processing section 29 of the order terminal 10, and displays the initial game screen 80 having all cards 81 not turned up on the display section 23 as the “picture matching game” (step S3). Next, in order to assign the same advertising image per two cards among eight cards 81, the advertising image selection section 16w selects four advertising images from the advertising image information database 16v, according to the various information that the product order management device 12 manages (step S4). Also, the process of the advertising image selection section 16w selecting the advertising image may be carried out at any given time prior to the game commencing.

Next, the user keeps turning over the cards 81 to play the game. At this point, the image control processing section 16b controls the game playback section 16a to use the advertising images 81′ selected by the advertising image selection section 16w as the character images used in the game screen 80 (step S5). Thus, the game processing section 29 of the order terminal 10 receives the game playback information from the game playback section 16a, and displays the game screen 80, including the advertising images 81′ selected by the advertising image selection section 16w, on the display section 23. At this point, when “call information” is included in the game playback information from the game playback section 16a, the game processing section 29 emits sound from the sound production section 24 according to the “call information”.

Next, according to the advertising image 81′ that is exposed every time the user turns over the card 81, the exposure count section 2A associates this with “advertising image data” that identifies the advertising image 81′ and counts the “exposure count”, and stores it in the game information storage section 22b. Also, when the advertising images that the user consecutively turned over twice are the same product, the score computing processing section 16f computes the total score by adding the predefined score for the correct answer, and stores it in the game information storage section 22b as “score information” (step S6).

Next, when the user has not finished the picture matching of four sets of cards and the game is not over (NO of step S7), it returns to step S4 and selects the advertising images that become the characters. However, when the advertising images that become the characters are not to be changed, step S4 is skipped and the process of step S5 is carried out. While step S7 is judged as NO, the processes of the steps from step S4 to step S7 described above are repeated. Next, when the user has finished the picture matching of four sets of cards and the game is over (YES of step S7), the game control section 16 compares the “computed score” that the score computing processing section 16f computes, with the “high score” referenced on the score information database 16y.

Here, when the score is higher than the “high score” (YES of step S8), the scorer information retrieval section 16h prompts the user to input a random character string that becomes the “scorer information”, and retrieves the “scorer information” of the user who marked the high score. Then, the database update section 16i associates the “computed score” with the “scorer information” retrieved by the scorer information retrieval section 16h, and stores it as a new “high score” in the score information database 16y (step S9). Then, the process relating to the game ends. Also, if the score is not higher than the “high score” (NO of step S8), the process relating to the game ends.

One embodiment of an advertising system including an ordering system has been described above. According to the combination of this ordering system and advertising system using the game, the service of a game that users can enjoy while not eating can be provided. Moreover, it has the effect of drawing more customers and increasing sales even outside mealtime hours, because there are customers visiting the store to play the game. Also, the “special menu” 73 (or game only) may be provided on an available terminal for users waiting for an available table. Furthermore, in order to increase user's turnover during meal time zones, use of the game may be restricted according to the time zone.

Also, the advertising system of the present invention can draw user's attention to the advertising image using the advertising image as a game character. Moreover, since the advertising system manages the “order information”, advertising images that facilitate effective advertising can be selected and displayed according to the “order information”. Also, since the advertising system counts the “exposure count” of an advertising image, it can charge according to the “exposure count”.

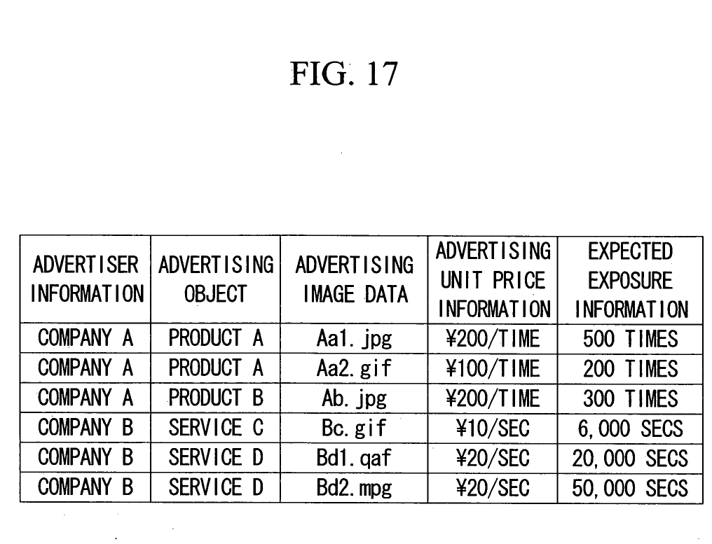

Here, one example of a charging method including charging according to the “exposure count” of the advertising image, and a data configuration for charging is described. FIG. 17 is a diagram showing a specific example of the information stored in the advertising image information database 16v for the advertising system to charge for the exposure of the advertising image, in the first embodiment of the present invention. As shown in the diagram, the name of advertisers (company A, company B) is stored as the “advertiser information”. Also, the name of products or services (product A, product B, service C, service D, etc.) is stored as the “advertising object”. The advertising images, which are still images in various file formats and motion picture files, and that advertise the product are stored as “advertising image data”.

Information relating to the price charged for every exposure or the price charged per unit of one second is stored as the “advertising unit price”. Information relating to the exposure count and exposure time of the advertising that the advertiser expects during a certain period is stored as the “expected exposure information”.

Also, although in the present embodiment, the information relating to charge is stored in the advertising image information database 16v mentioned above, an additional charge information database may be provided and the charge information may be managed for separate advertisers. Moreover, for the motion picture, a motion picture such as one used for television broadcasting may be used. However a touch panel that users can operate on may be employed, and the use of the product can be promoted virtually, and an advertising method that describes the usage of the product and so on may also be carried out.

Furthermore, in order to urge customers to come back to the store, various services using the score information may be carried out. For example, the score information display processing section 16g may display the top scorer of the game on the display section 23, or a reward may be offered free of charge to a high scorer inside a predefined period. Also, although a method to retrieve the scorer information has been described above as a high scorer identification method, it is not limited to this, and a method may be employed such as one in which a card on which an identification code that identifies the scorer is printed, is outputted and given to the scorer, or the user is required to input an email address and the character string that identifies the scorer is delivered to the email address.

Also, apart from the “picture matching game” mentioned above, the games described below are preferable as games that draw user's attention to the advertising image.

“Picture Matching Puzzle Game”

The advertising image is divided into sixteen blocks, and each of the blocks is randomly positioned at an initial state. The user is to complete the original advertising image by moving the randomly positioned blocks.

“Whack-A-Mole Game”

The target character to be whacked is the advertising image. Also, the user's attention can be drawn more to the intended advertising image by assigning different points to the various types of products of the advertising images, and assigning higher points to the advertising image of the product desired to draw more attention.

“Image Memory Game”

First a plurality of advertising images is displayed for a moment, and the user is allowed to memorize their positions. Then, the user is made to recall the positions of each advertising image.

“Spot-The-Difference Game”

Firstly, the original advertising image is displayed for a given length of time to let the user memorize the image. Then, an advertising image that is different in a few places from the original advertising image is displayed, and the user is to spot the different places (difference). This may be applied to a motion picture so that a motion picture having a few different movements from the original motion picture is displayed and the user is to point out (or select) the parts having different movements.

Moreover, as a second embodiment of the present invention, an advertising system that provides advertising using games on information terminals (user terminals) installed at, for example, a shopping mall, a theme park or a station to provide users with various information, is described.

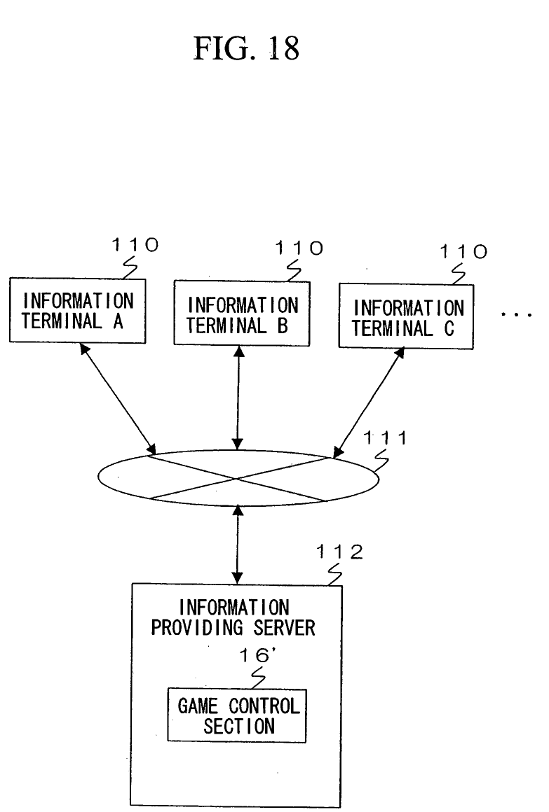

FIG. 18 is a block diagram showing a schematic construction of an advertising system employing a game according to a second embodiment of the present invention.

In the diagram, reference symbol 110 denotes an information terminal A, an information terminal B, an information terminal C, etc. (hereinafter referred to as information terminals 110) installed at a shopping mall, theme park or station to provide users with various kinds of information. Reference symbol 111 denotes a communication network such as the Internet or a dedicated circuit. Reference symbol 112 denotes an information providing server that transmits various kinds of information to the information terminal 110 via the communication network 111. Also, the information providing server 112 has a game control section 16′ that has the same functionalities that the above mentioned game control section 16 has. In the present embodiment, the information terminal 110 downloads a game program from the information providing server 112 and executes it, so that the user can play the game.

The operation of the above mentioned advertising system is described.

Firstly, the information terminal 110 requests the game program from the information providing server 112 via the communication network 111. Then, the game control section 16′ of the information providing server 112 carries out the following process. Firstly, if the game type, the location of installation of the information terminal 110 that requested the game program, the time and information relating to the user are received from the information terminal 110, the advertising image selection section 16w selects the advertising image that is judged to have high advertising effectiveness from the advertising image information database 16v, according to information such as that user information. Then, the playback control section 16d reads the game program from the game information database 16x, and compiles the game program to use as a character image the advertising image that the advertising image selection section 16w has selected.

Also, the playback control section 16d compiles the game program to use a score computing program, which computes a score by a predefined formula using the score information for individual advertising images. Moreover, if “call information” for producing sound in response to the advertising image being displayed is present, the playback control section 16d compiles the game program together with a calling program that uses the “call information”. As described above, the game control section 16′ of the information providing server 112 generates a game program having various functionalities and transmits it to the information terminal 110. Thus, the information terminal 110 is able to download the game program. Then, the information terminal 110 provides the game using the advertising images as characters, by executing the game program.

Furthermore, the exposure count of the advertising image can be counted by further including an exposure count computing program that counts the exposure count of the advertising images in the game program. As described above, the advertising system of the second embodiment of the present invention can provide games using advertising images as characters to information terminals installed at various locations. Also, the advertising effectiveness can be further improved by providing games of the type that draw attention to the above mentioned advertising images, as the games provided.

Moreover, each of processes may be carried out by recording the programs that realize the functions of the processing sections shown in FIG. 2, FIG. 3, and FIG. 4 that carry out various processes, on a computer-readable recording media, and loading the programs recorded on this recording media into a computer server, and executing them. Also, the term “a computer server” here includes an OS and hardware such as peripheral devices.

Moreover, if a WWW server is used, the “computer server” includes an environment to provide a homepage (or a display environment).

Furthermore, the “computer-readable recording media” refers to a removable media such as a flexible disk, a magnetic optical disk, ROM, CD-ROM, and a memory device such as a built-in hard disk of the computer server. Furthermore, the “computer-readable recording media” is taken as including something that holds a program for a given length of time such as the built-in volatile memory (RAM) of a computer server that acts as a server or a client when a program is transmitted via a network such as the Internet or a communication line such as a telephone line.

Also, the above-mentioned program may be transferred from a computer server storing this program on its memory device to another computer server via a transfer medium or transmission waves in the transfer medium. Here, the “transfer medium” that transfers the program refers to a medium having a functionality of transferring information such as a network (communication network), such as the Internet, or a communication line (communication line), such as a telephone line.

Moreover, the program mentioned above, may be to realize some of the functions mentioned above. Furthermore, it may be what is called a patch file (patch program) that is capable of realizing the functions mentioned above by combining with programs already recorded on the computer server.

Although the embodiments of the present invention have been described above in detail making reference to the diagrams, the specific construction is not limited to these embodiments, and designs within a scope which does not depart from the gist of the present invention are also included.

1. An advertising system having a game playback device that provides a game screen in a display section of a user terminal, comprising:
an image control device for controlling said game playback device so that said game playback device employs an advertising image that is an image for advertising a product or a service, as a character image used in said game screen.

2. An advertising system according to claim 1, further comprising:
a playback control device that controls said game playback device so as to include an order detection device that detects said product or said service displayed in said game screen as said character image; and
an order information receiving device that receives order information related to the order of said product or said service detected by said order detection device.

3. An advertising system according to claim 1, comprising:
an advertising image information database that stores advertising image information, which is information related to said product or said service including advertising image data which are electronic data of said advertising image; and
an advertising image selection device that selects said advertising image having a better advertising effectiveness from said advertising image database, according to one or a plurality of information from among; information related to a store where said user terminal is installed, a period of time, a date, a day of the week, and a time elapsed from a predetermined event related to the user using said user terminal taken as a start time.

4. An advertising system according to claim 1, further comprising:
a score computing device, which computes a score by carrying out predetermined calculations according to a course of a game;
a score information database which sorts past scores in descending order and assigns ranks to them, and associates and stores top scores that are ranked above a predetermined rank with scorer information, which is information related to the users who played the game and gained the top scores; and
a score information display device which associates said top scores and said scorer information referenced from said score information database and displays them on said display section.

5. An advertising system according to claim 4, further comprising:
a scorer information retrieval device which retrieves said scorer information when a computed score, which is a score that said computing device computes, is greater than said top score referenced from said score information database; and
a database update device which stores said computed score associated with retrieved scorer information, as a new top score in said score information database.

6. An advertising system according to claim 1, further comprising an image enlargement device that enlarges said advertising image and displays it on said display section.

7. An advertising system according to claim 1, wherein in a case where said user terminal has a sound emitting device that emits sound, said advertising image information additionally includes call information for calling information relating to said product or said service, and further comprising:
a call control device that controls said sound emitting device to make reference to said call information included in said advertising image information from said advertising image information database, and call out information relating to the product or service.

8. An advertising method for employing a game playback device that provides a game screen on a display section of a user terminal, comprising:
controlling said game playback device to allow said game playback device to employ an advertising image that is an image for advertising a product or a service, as a character image used in said game screen.

9. A program for an advertising system having a game playback device that provides a game screen on a display section of a user terminal, wherein said program controls a computer so that said game playback device employs an advertising image that is an image for advertising a product or a service, as a character image used in said game screen.
